(19) United States
(12) Patent Application Publication
(10) Pub. No.: US 2024/0412885 A1
(43) Pub. Date: Dec. 12, 2024

(54) RADIOACTIVE WASTE CANISTER SYSTEMS AND METHODS

(71) Applicant: Deep Isolation, Inc., Berkeley, CA (US)

(72) Inventor: Richard A. Muller, Berkeley, CA (US)

(21) Appl. No.: 18/695,509

(22) PCT Filed: Sep. 30, 2022
(86) PCT No.: PCT/US2022/045434

§ 371 Date: Mar. 26, 2024

Related U.S. Application Data
(60) Provisional application No. 63/250,510, filed on Sep. 30, 2021.
(60) Provisional application No. 63/275,622, filed on Nov. 4, 2021.

(51) Int. Cl. G21F 5/002; G21F 5/008; G21F 5/12

(52) U.S. Cl. CPC G21F 5/002; G21F 5/008; G21F 5/12

(57) ABSTRACT

A hazardous waste canister includes a housing that includes at least one open end and defines an interior volume; and an end cap sized and configured to attach to the at least one open end of the housing to enclose the interior volume. The housing is configured to enclose a plurality of nuclear waste forms within the interior volume, with at least one of the plurality of nuclear waste forms different than at least another of the plurality of nuclear waste forms.

### TECHNICAL FIELD

This disclosure relates to canister systems and methods for storing radioactive and other waste, such as in deep, human-unoccupiable drillholes formed in a subterranean formation.

### BACKGROUND

Hazardous waste is often placed in long-term, permanent, or semi-permanent storage so as to prevent health issues among a population living near the stored waste. Such hazardous waste storage is often challenging, for example, in terms of storage location identification and surety of containment. For instance, the safe storage of nuclear waste (e.g., spent nuclear fuel, whether from commercial power reactors, test reactors, or even military waste) is considered to be one of the outstanding challenges of energy technology. Safe storage of the long-lived radioactive waste is a major impediment to the adoption of nuclear power in the United States and around the world. Conventional waste storage methods have emphasized the use of tunnels, and is exemplified by the design of the Yucca Mountain storage facility. Other techniques include boreholes, including vertical boreholes, drilled into crystalline basement rock. Other conventional techniques include forming a tunnel with boreholes emanating from the walls of the tunnel in shallow formations to allow human access.

### SUMMARY

In an example implementation, a hazardous waste canister includes a housing that includes at least one open end and defines an interior volume; and an end cap sized and configured to attach to the at least one open end of the housing to enclose the interior volume. The housing is configured to enclose a plurality of nuclear waste forms within the interior volume, with at least one of the plurality of nuclear waste forms different than at least another of the plurality of nuclear waste forms.

In an aspect combinable with the example implementation, the housing is configured to prevent passage of a radioactive fluid there through.

In another aspect combinable with any of the previous aspects, the housing is further configured to allow passage of a plurality of gamma rays generated by the plurality of nuclear waste forms there through.

In another aspect combinable with any of the previous aspects, the end cap is configured to prevent passage of a radioactive fluid there through, and the end cap is further configured to prevent passage of a plurality of gamma rays generated by the plurality of nuclear waste forms there through.

In another aspect combinable with any of the previous aspects, the housing is made of at least one of a carbon-steel, a stainless steel, or a nickel alloy.

In another aspect combinable with any of the previous aspects, the end cap is made of at least one of lead or tungsten.

In another aspect combinable with any of the previous aspects, the at least one open end includes a first open end at a first end of the housing and a second open end at a second end of the housing opposite the first end.

Another aspect combinable with any of the previous aspects further includes another end cap sized and configured to attach to at least one of the first or second open ends to at least partially enclose the interior volume.

In another aspect combinable with any of the previous aspects, the plurality of nuclear waste forms include at least two of Cesium-137 or Strontium-90 capsules; spent nuclear fuel pellets; vitrified nuclear waste that includes glass-encased nuclear fuel; one or more fragments of a melted nuclear core; calcine waste that includes a granular solid; pebble bed nuclear reactor pellets; or a portion of transuranic waste.

In another aspect combinable with any of the previous aspects, the housing is configured to enclose a granular material to fill one or more voids in the interior volume between the plurality of nuclear waste forms.

In another aspect combinable with any of the previous aspects, the granular material includes sand.

In another aspect combinable with any of the previous aspects, the sand includes quartz.

In another aspect combinable with any of the previous aspects, the granular material includes aerogel material.

In another aspect combinable with any of the previous aspects, the granular material includes hollow glass spheres.

In another aspect combinable with any of the previous aspects, the housing is configured to enclose a mixture that includes the granular material and the plurality of nuclear waste forms.

In another aspect combinable with any of the previous aspects, the housing is configured to enclose a lubricant.

In another aspect combinable with any of the previous aspects, the housing is configured to enclose a mixture that includes the granular material, the plurality of nuclear waste forms, and the lubricant.

In another aspect combinable with any of the previous aspects, a difference in the at least one of the plurality of nuclear waste forms and the at least another of the plurality of nuclear waste forms includes at least one of a size, a shape, or a type of nuclear waste.

In another example implementation, a method includes identifying a hazardous waste canister that includes a housing that includes at least one open end and defines an interior volume; moving a plurality of nuclear waste forms through the at least one open end and into the interior volume; and sealing the at least one open end with an end cap sized and configured to attach to the at least one open end of the housing. At least one of the plurality of nuclear waste forms is different than at least another of the plurality of nuclear waste forms.

In an aspect combinable with the example implementation, the housing is configured to prevent passage of a radioactive fluid there through, and the housing is further configured to allow passage of a plurality of gamma rays generated by the plurality of nuclear waste forms there through.

In another aspect combinable with any of the previous aspects, the end cap is configured to prevent passage of a radioactive fluid there through, and the end cap is further configured to prevent passage of a plurality of gamma rays generated by the plurality of nuclear waste forms there through.

In another aspect combinable with any of the previous aspects, the housing is made of at least one of a carbon-steel, a stainless steel, or a nickel alloy.

In another aspect combinable with any of the previous aspects, the end cap is made of at least one of lead or tungsten.

In another aspect combinable with any of the previous aspects, the at least one open end includes a first open end at a first end of the housing and a second open end at a second end of the housing opposite the first end, and the canister further includes another end cap sized and configured to attach to at least one of the first or second open ends to at least partially enclose the interior volume.

In another aspect combinable with any of the previous aspects, the plurality of nuclear waste forms include at least two of: Cesium-137 or Strontium-90 capsules; spent nuclear fuel pellets; vitrified nuclear waste that includes glass-encased nuclear fuel; one or more fragments of a melted nuclear core: calcine waste that includes a granular solid; pebble bed nuclear reactor pellets; or a portion of transuranic waste.

Another aspect combinable with any of the previous aspects further includes inserting a granular material into the interior volume to fill one or more voids in the interior volume between the plurality of nuclear waste forms.

In another aspect combinable with any of the previous aspects, the granular material includes a sand.

In another aspect combinable with any of the previous aspects, the sand includes quartz.

In another aspect combinable with any of the previous aspects, the granular material includes aerogel material.

In another aspect combinable with any of the previous aspects, the granular material includes hollow glass spheres.

Another aspect combinable with any of the previous aspects further includes inserting a mixture that includes the granular material and the plurality of nuclear waste forms into the interior volume.

Another aspect combinable with any of the previous aspects further includes inserting a lubricant into the interior volume.

Another aspect combinable with any of the previous aspects further includes inserting a mixture that includes the granular material, the plurality of nuclear waste forms, and the lubricant into the interior volume.

In another aspect combinable with any of the previous aspects, a difference in the at least one of the plurality of nuclear waste forms and the at least another of the plurality of nuclear waste forms includes at least one of a size, a shape, or a type of nuclear waste.

Another aspect combinable with any of the previous aspects further includes repeatedly moving the canister to mix the granular material and the plurality of nuclear waste forms in the interior volume.

Another aspect combinable with any of the previous aspects further includes repeatedly moving the canister to mix the granular material, the plurality of nuclear waste forms, and the lubricant in the interior volume.

In another aspect combinable with any of the previous aspects, repeatedly moving includes shaking or vibrating.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a hazardous waste repository during storage or disposal of multiple forms of radioactive or other waste in one or more hazardous waste canisters according to the present disclosure.

FIG. 2 is a schematic illustration of an example implementation of a radioactive waste canister system according to the present disclosure.

FIG. 3 is a schematic illustration of another example implementation of a radioactive waste canister system according to the present disclosure.

FIG. 4A is a schematic illustration of an example system for vitrifying nuclear waste according to the present disclosure.

FIG. 4B is a schematic illustration of a system and process for emplacing vitrified waste in hazardous waste canister systems according to the present disclosure.

FIG. 5 is a schematic illustration of a controller or control system according to the present disclosure.

### DETAILED DESCRIPTION

Hazardous waste, such as radioactive waste (e.g., spent nuclear fuel, high level waste, transuranic (TRU) waste, and other waste) can be disposed (permanently or for a certain period of time) in one or more canisters in a hazardous waste repository formed in one or more deep, directional drillholes (e.g., also called wellbores or boreholes). Each drillhole is formed from a terranean surface and extends through one or more subterranean formation and lands (e.g., as a horizontal drillhole) in a particular subterranean formation (e.g., shale, salt, crystalline basement rock, or other formation). The drillholes can be drilled as conventional wells, which are unoccupiable by humans (unlike conventional waste repositories that are mined and therefore allow for human occupation in at least a portion thereof).

Such directional drillholes often include horizontal drillhole portions formed at a depth between 1 and 3 km and include a hazardous waste storage portion (or area), that is typically near the ends of the respective horizontal drillhole portions (opposite their connections to vertical portions). Such hazardous waste storage portion can also be called disposal regions. These disposal regions can be tens to thousands of meters long. Nuclear waste such as spent nuclear fuel (SNF) and other toxic materials can be placed in the disposal regions (for example, within hazardous waste canisters).

The present disclosure describes methods and systems for monitoring waste stored in directional drillholes in which conditions close to the drillhole (e.g., a few meters) are monitored rather than, for example, conditions within or very close (e.g., inches) to the drillhole. For example, in some aspects, conditions a few meters from the disposal region can be fundamental to human safety, because conditions at that distance can be indicative of movement of the waste out of the repository, or changes in the condition of the rock that can allow such movement to occur in the future. Such measurements can be possibly even more important than are the closer measurements. For example, if radiation increases with time at a distance a few meters from the disposal region, then that can indicate that leakage has occurred. Measurements of temperature in this region can show if the calculations of temperature rise are occurring as expected. Changes in the pH and salinity of the water can indicate flow of water, a potential source of leakage.

The present disclosure further describes a hazardous waste repository, which includes one or more drillholes formed into a subterranean zone to provide long-term (e.g., tens, hundreds, or even thousands of years) storage of hazardous material (e.g., biological, chemical, nuclear, or otherwise) in one or more underground storage volumes storage canisters. The subterranean zone includes multiple subterranean layers having different geological formations and properties. The storage canisters may be deposited in a particular subterranean layer based on one or more geologic properties of that layer, such as low permeability, sufficient thickness, low brittleness, and other properties. In some aspects, the particular subterranean layer comprises a shale formation, which forms an isolative seal between the storage canisters and another subterranean layer that comprises mobile water.

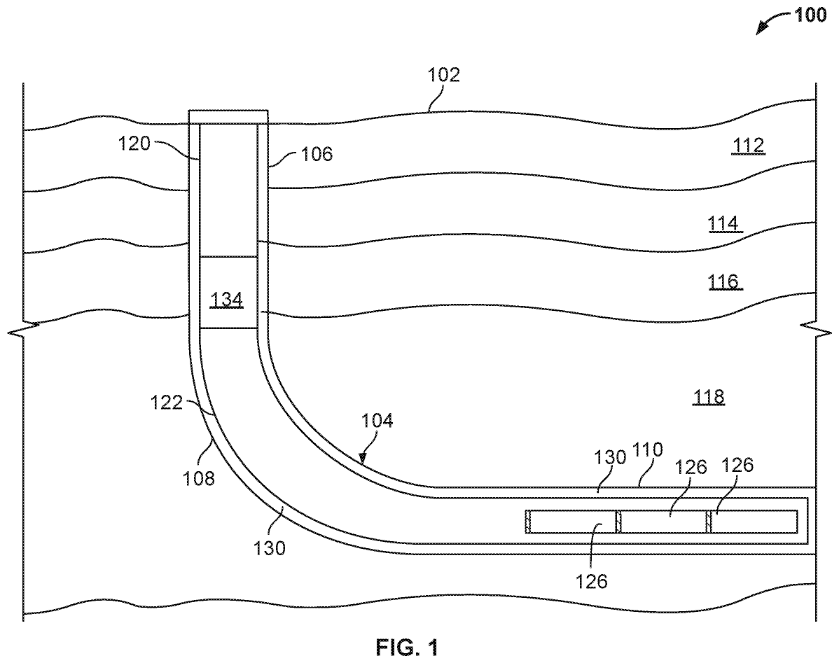

FIG. 1 is schematic illustrations of example implementations of a hazardous waste repository, e.g., a subterranean location for the long-term (e.g., tens, hundreds, or thousands of years or more) but retrievable safe and secure storage of hazardous material, during a deposit or retrieval operation according to the present disclosure. For example, this figure illustrates an example hazardous waste repository 100 once one or more hazardous waste canisters 126 have been moved into a drillhole 104 (e.g., wellbore or borehole). As illustrated, the hazardous waste repository 100 includes a drillhole 104 formed (e.g., drilled or otherwise) from a terranean surface 102 and through multiple subterranean layers 112, 114, 116, and 118. Although the terranean surface 102 is illustrated as a land surface, terranean surface 102 may be a sub-sea or other underwater surface, such as a lake or an ocean floor or other surface under a body of water. Thus, the present disclosure contemplates that the drillhole 104 may be formed under a body of water from a drilling location on or proximate the body of water.

The illustrated drillhole 104 is a directional drillhole in this example of hazardous waste repository 100. For instance, the drillhole 104 includes a substantially vertical portion 106 coupled to a radiussed or curved portion 108, which in turn is coupled to a substantially horizontal portion 110. As used in the present disclosure, “substantially” in the context of a drillhole orientation, refers to drillholes that may not be exactly vertical (e.g., exactly perpendicular to the terranean surface 102) or exactly horizontal (e.g., exactly parallel to the terranean surface 102). In other words, those of ordinary skill in the drill arts would recognize that vertical drillholes often undulate offset from a true vertical direction, that they might be drilled at an angle that deviates from true vertical, and horizontal drillholes often undulate offset from a true horizontal direction. Further, the substantially horizontal portion 110, in some aspects, may be a slant drillhole or other directional drillhole that is oriented between exactly vertical and exactly horizontal. Further, the substantially horizontal portion 110, in some aspects, may be a slant drillhole or other directional well bore that is oriented to follow the slant of the formation. As illustrated in this example, the three portions of the drillhole 104—the vertical portion 106, the radiussed portion 108, and the horizontal portion 110—form a continuous drillhole 104 that extends into the Earth.

The illustrated drillhole 104 has a surface casing 120 positioned and set around the drillhole 104 from the terranean surface 102 into a particular depth in the Earth. For example, the surface casing 120 may be a relatively large-diameter tubular member (or string of members) set (e.g., cemented) around the drillhole 104 in a shallow formation. As used herein, “tubular” may refer to a member that has a circular cross-section, elliptical cross-section, or other shaped cross-section. For example, in this implementation of the hazardous waste repository 100, the surface casing 120 extends from the terranean surface through a surface layer 112. The surface layer 112, in this example, is a geologic layer comprised of one or more layered rock formations. In some aspects, the surface layer 112 in this example may or may not include freshwater aquifers, salt water or brine sources, or other sources of mobile water (e.g., water that moves through a geologic formation). In some aspects, the surface casing 112 may isolate the drillhole 104 from such mobile water, and may also provide a hanging location for other casing strings to be installed in the drillhole 104. Further, although not shown, a conductor casing may be set above the surface casing 112 (e.g., between the surface casing 112 and the surface 102 and within the surface layer 112) to prevent drilling fluids from escaping into the surface layer 112.

As illustrated, a production casing 122 is positioned and set within the drillhole 104 downhole of the surface casing 120. Although termed a “production” casing, in this example, the casing 122 may or may not have been subject to hydrocarbon production operations. Thus, the casing 122 refers to and includes any form of tubular member that is set (e.g., cemented) in the drillhole 104 downhole of the surface casing 120. In some examples of the hazardous waste repository 100, the production casing 122 may begin at an end of the radiussed portion 108 and extend throughout the substantially horizontal portion 110. The casing 122 can also extend into the radiussed portion 108 and into the vertical portion 106.

As shown, cement 130 is positioned (e.g., pumped) around the casings 120 and 122 in an annulus between the casings 120 and 122 and the drillhole 104. The cement 130, for example, may secure the casings 120 and 122 (and any other casings or liners of the drillhole 104) through the subterranean layers under the terranean surface 102. In some aspects, the cement 130 may be installed along the entire length of the casings (e.g., casings 120 and 122 and any other casings), or the cement 130 can be used along certain portions of the casings if adequate for a particular drillhole 104. The cement 130 can also provide an additional layer of confinement for the hazardous material in canisters 126.

The drillhole 104 and associated casings 120 and 122 may be formed with various example dimensions and at various example depths (e.g., true vertical depth, or TVD). For instance, a conductor casing (not shown) may extend down to about 120 feet TVD, with a diameter of between about 28 in. and 60 in. The surface casing 120 may extend down to about 2500 feet TVD, with a diameter of between about 22 in. and 48 in. An intermediate casing (not shown) between the surface casing 120 and production casing 122 may extend down to about 8000 feet TVD, with a diameter of between about 16 in. and 36 in. The production casing 122 may extend substantially horizontally (e.g., to case the substantially horizontal portion 110) with a diameter of between about 11 in. and 22 in. The foregoing dimensions are merely provided as examples and other dimensions (e.g., diameters, TVDs, lengths) are contemplated by the present disclosure. For example, diameters and TVDs may depend on the particular geological composition of one or more of the multiple subterranean layers (112-118), particular drilling techniques, as well as a size, shape, or design of a hazardous material canister 126 that contains hazardous material to be deposited in the hazardous waste repository 100. In some alternative examples, the production casing 122 (or other casing in the drillhole 104) can be circular in cross-section, elliptical in cross-section, or some other shape.

As illustrated, the drillhole 104 extends through subterranean layers 112, 114, and 116, and lands in subterranean layer 118. As discussed above, the surface layer 112 may or may not include mobile water. Subterranean layer 114, which is below the surface layer 112, in this example, is a mobile water layer 114. For instance, mobile water layer 114 may include one or more sources of mobile water, such as freshwater aquifers, salt water or brine, or other source of mobile water. In this example of hazardous waste repository 100, mobile water may be water that moves through a subterranean layer based on a pressure differential across all or a part of the subterranean layer. For example, the mobile water layer 114 may be a permeable geologic formation in which water freely moves (e.g., due to pressure differences or otherwise) within the layer 114. In some aspects, the mobile water layer 114 may be a primary source of human-consumable water in a particular geographic area. Examples of rock formations of which the mobile water layer 114 may be composed include porous sandstones and limestones, among other formations.

Below the mobile water layer 114, in this example implementation of hazardous waste repository 100, is an impermeable layer 116. The impermeable layer 116, in this example, may not allow mobile water to pass through. Thus, relative to the mobile water layer 114, the impermeable layer 116 may have low permeability, e.g., on the order of nanodarcy permeability. Additionally, in this example, the impermeable layer 116 may be a relatively non-ductile (i.e., brittle) geologic formation. One measure of non-ductility is brittleness, which is the ratio of compressive stress to tensile strength. In some examples, the brittleness of the impermeable layer 116 may be between about 20 MPa and 40 MPa.

As shown in this example, the impermeable layer 116 is shallower (e.g., closer to the terranean surface 102) than the storage layer 119. In this example rock formations of which the impermeable layer 116 may be composed include, for example, certain kinds of sandstone, mudstone, clay, and slate that exhibit permeability and brittleness properties as described above. In alternative examples, the impermeable layer 116 may be deeper (e.g., further from the terranean surface 102) than the storage layer 119. In such alternative examples, the impermeable layer 116 may be composed of an igneous rock, such as granite.

Below the impermeable layer 116 is a storage layer 118. The storage layer 118, in this example, may be chosen as the landing for the substantially horizontal portion 110, which stores the hazardous material, for several reasons. Relative to the impermeable layer 116 or other layers, the storage layer 118 may be thick, e.g., between about 100 and 200 feet of total vertical thickness. Thickness of the storage layer 118 may allow for easier landing and directional drilling, thereby allowing the substantially horizontal portion 110 to be readily emplaced within the storage layer 118 during constructions (e.g., drilling). If formed through an approximate horizontal center of the storage layer 118, the substantially horizontal portion 110 may be surrounded by about 50 to 100 feet of the geologic formation that comprises the storage layer 118. Further, the storage layer 118 may also have no mobile water, e.g., due to a very low permeability of the layer 118 (e.g., on the order of milli-or nanodarcys). In addition, the storage layer 118 may have sufficient ductility, such that a brittleness of the rock formation that comprises the layer 118 is between about 3 MPa and 10 MPa.

Examples of rock formations of which the storage layer 118 may be composed include: shale and anhydrite. Further, in some aspects, hazardous material may be stored below the storage layer, even in a permeable formation such as sandstone or limestone, if the storage layer is of sufficient geologic properties to isolate the permeable layer from the mobile water layer 114.

In some examples implementations of the hazardous waste repository 100, the storage layer 118 is composed of shale. Shale, in some examples, may have properties that fit within those described above for the storage layer 118. For example, shale formations may be suitable for a long-term confinement of hazardous material (e.g., in the hazardous material canisters 126), and for their isolation from mobile water layer 114 (e.g., aquifers) and the terranean surface 102. Shale formations may be found relatively deep in the Earth, typically 3000 feet or greater, and placed in isolation below any fresh water aquifers.

Shale formations, for instance, may include geologic properties that enhance the long-term (e.g., thousands of years) isolation of material. Such properties, for instance, have been illustrated through the long term storage (e.g., tens of millions of years) of hydrocarbon fluids (e.g., gas, liquid, mixed phase fluid) without escape of such fluids into surrounding layers (e.g., mobile water layer 114). Indeed, shale has been shown to hold natural gas for millions of years or more, giving it a proven capability for long-term storage of hazardous material. Example shale formations (e.g., Marcellus, Eagle Ford, Barnett, and otherwise) has stratification that contains many redundant sealing layers that have been effective in preventing movement of water, oil, and gas for millions of years, lacks mobile water, and can be expected (e.g., based on geological considerations) to seal hazardous material (e.g., fluids or solids) for thousands of years after deposit.

Shale formations may also be at a suitable depth, e.g., between 3000 and 12,000 feet TVD. Such depths are typically below ground water aquifer (e.g., surface layer 112 and/or mobile water layer 114). Further, the presence of soluble elements in shale, including salt, and the absence of these same elements in aquifer layers, demonstrates a fluid isolation between shale and the aquifer layers.

Another particular quality of shale that may advantageously lend itself to hazardous material storage is its clay content, which, in some aspects, provides a measure of ductility greater than that found in other, impermeable rock formations (e.g., impermeable layer 116). For example, shale may be stratified, made up of thinly alternating layers of clays (e.g., between about 20-30% clay by volume) and other minerals. Such a composition may make shale less brittle and, thus less susceptible to fracturing (e.g., naturally or otherwise) as compared to rock formations in the impermeable layer (e.g., granite or otherwise). For example, rock formations in the impermeable layer 116 may have suitable permeability for the long term storage of hazardous material, but are too brittle and commonly are fractured. Thus, such formations may not have sufficient sealing qualities (as evidenced through their geologic properties) for the long term storage of hazardous material.

The present disclosure contemplates that there may be many other layers between or among the illustrated subterranean layers 112, 114, 116, and 118. For example, there may be repeating patterns (e.g., vertically), of one or more of the mobile water layer 114, impermeable layer 116, and storage layer 118. Further, in some instances, the storage layer 118 may be directly adjacent (e.g., vertically) the mobile water layer 114, i.e., without an intervening impermeable layer 116.

The hazardous waste canisters 126 can be emplaced through a deposit operation into the horizontal portion 110 of the drillhole 104. For example, a work string (e.g., tubing, coiled tubing, wireline, or otherwise) can be extended into the cased drillhole 104 to place one or more (three shown but there may be more or less) hazardous material canisters 126 into long term, but in some aspects, retrievable, storage in the portion 110. A work string may include a downhole tool that couples to the canister 126, and with each trip into the drillhole 104, the downhole tool may deposit a particular hazardous material canister 126 in the substantially horizontal portion 110.

The downhole tool may couple to the canister 126 by, in some aspects, a threaded connection. In alternative aspects, the downhole tool may couple to the canister 126 with an interlocking latch, such that rotation of the downhole tool may latch to (or unlatch from) the canister 126. In alternative aspects, the downhole tool may include one or more magnets (e.g., rare Earth magnets, electromagnets, a combination thereof, or otherwise) which attractingly couple to the canister 126. In some examples, the canister 126 may also include one or more magnets (e.g., rare Earth magnets, electromagnets, a combination thereof, or otherwise) of an opposite polarity as the magnets on the downhole tool. In some examples, the canister 126 may be made from or include a ferrous or other material attractable to the magnets of the downhole tool.

As another example, each canister 126 may be positioned within the drillhole 104 by a drillhole tractor (e.g., on a wireline or otherwise), which may push or pull the canister into the substantially horizontal portion 110 through motorized (e.g., electric) motion. As yet another example, each canister 126 may include or be mounted to rollers (e.g., wheels), so that the downhole tool may push the canister 126 into the cased drillhole 104.

Each canister 126 may enclose hazardous material. Such hazardous material, in some examples, may be biological or chemical waste or other biological or chemical hazardous material. In some examples, the hazardous material may include nuclear material, such as spent nuclear fuel recovered from a nuclear reactor (e.g., commercial power or test reactor) or military nuclear material. For example, a gigawatt nuclear plant may produce 30tons of spent nuclear fuel per year. The density of that fuel is typically close to 10 (10 gm/cm³=10 kg/liter), so that the volume for a year of nuclear waste is about 3 m³. Spent nuclear fuel, in the form of nuclear fuel pellets, may be taken from the reactor and not modified. Nuclear fuel pellets are solid, and emit very little gas other than short-lived tritium (13 year half-life).

Each hazardous waste canister 126, as explained more fully within, can enclose multiple, different forms of radioactive waste for storage or disposal. For example, Nuclear waste comes in many forms. The most dangerous waste is high-level or highly radioactive waste. There are many examples of nuclear waste forms, including:
(1) Cesium-137 and Strontium-90, currently in temporary storage at the U.S. Hanford Laboratory. This form of nuclear waste consists of capsules that are 9 cm (3.5 inches) in diameter and 60 cm (24 inches) long.
(2) Spent nuclear fuel from commercial nuclear reactors. This form of nuclear waste consists of 1-cm size pellets held in “fuel assemblies” that are rod shaped and typically 20 to 30 cm in diameter and 4 m long.
(3) Vitrified waste. This form of nuclear waste is nuclear fuel that may have been reprocessed but is currently encased in glass. The glass serves as an “engineered barrier” to absorb short-range nuclear radiation (e.g., alpha and beta particles) and to partially contain radionuclides that can diffuse out from the nuclear fuel. The cylinders of glass are typically 30 to 45 cm in diameter and 3 meters long.
(4) Fragments of melted core from nuclear accidents. This form of nuclear waste generally does not have a standardized shape or size.
(5) Calcine waste. This form of nuclear waste is formerly liquid but has been converted to a granular solid in no standardized shape or size.
(6) Fourth generation nuclear reactor waste (including, for example, advanced reactor waste). This form of nuclear waste can come in many types. One example type includes the fuel for “pebble bed” nuclear reactors that consists of 6.7 cm (2.6 inches) diameter pellets (e.g., about the size of tennis balls). If this fuel is reprocessed (and some of it is intended for that), then the final format of the fuel may not be determined.
(7) Transuranic (or TRU) waste. This form of nuclear waste is currently disposed at the Waste Isolation Pilot Plant in New Mexico within 15 or 30 gallon drums (with diameters between 14 and 19 inches).

This list of nuclear waste forms between (1)-(7) is not meant to be comprehensive; for example, there are many forms of medical waste, research waste, and defense waste. But the variety that this list exhibits illustrates the challenge of disposing of the radioactive waste in a universal manner.

In some aspects, the storage layer 118 should be able to contain any radioactive output (e.g., including gases) within the layer 118, even if such output escapes the canisters 126. For example, the storage layer 118 may be selected based on diffusion times of radioactive output through the layer 118. For example, a minimum diffusion time of radioactive output escaping the storage layer 118 may be set at, for example, fifty times a half-life for any particular component of the nuclear fuel pellets. Fifty half-lives as a minimum diffusion time would reduce an amount of radioactive output by a factor of 1×10⁻¹⁵. As another example, setting a minimum diffusion time to thirty half-lives would reduce an amount of radioactive output by a factor of one billion.

For example, plutonium-239 is often considered a dangerous waste product in spent nuclear fuel because of its long half-life of 24,100 years. For this isotope, 50 half-lives would be 1.2 million years. Plutonium-239 has low solubility in water, is not volatile, and as a solid is not capable of diffusion through a matrix of the rock formation that comprises the illustrated storage layer 118 (e.g., shale or other formation). The storage layer 118, for example comprised of shale, may offer the capability to have such isolation times (e.g., millions of years) as shown by the geological history of containing gaseous hydrocarbons (e.g., methane and otherwise) for several million years. In contrast, in conventional nuclear material storage methods, there was a danger that some plutonium might dissolve in a layer that comprised mobile ground water upon confinement escape.

In some aspects, the drillhole 104 may be formed for the primary purpose of long-term storage of hazardous materials. In alternative aspects, the drillhole 104 may have been previously formed for the primary purpose of hydrocarbon production (e.g., oil, gas). For example, storage layer 118 may be a hydrocarbon bearing formation from which hydrocarbons were produced into the drillhole 104 and to the terranean surface 102. In some aspects, the storage layer 118 may have been hydraulically fractured prior to hydrocarbon production. Further in some aspects, the production casing 122 may have been perforated prior to hydraulic fracturing. In such aspects, the production casing 122 may be patched (e.g., cemented) to repair any holes made from the perforating process prior to a deposit operation of hazardous material. In addition, any cracks or openings in the cement between the casing and the drill hole can also be filled at that time.

For example, in the case of spent nuclear fuel as a hazardous material, the drillhole 104 may be formed at a particular location, e.g., near a nuclear power plant, as a new drillhole provided that the location also includes an appropriate storage layer 118, such as a shale formation. Alternatively, an existing well that has already produced shale gas, or one that was abandoned as “dry,” (e.g., with sufficiently low organics that the gas in place is too low for commercial development), may be selected as the drillhole 104. In some aspects, prior hydraulic fracturing of the storage layer 118 through the drillhole 104 may make little difference in the hazardous material storage capability of the drillhole 104. But such a prior activity may also confirm the ability of the storage layer 118 to store gases and other fluids for millions of years. If, therefore, the hazardous material or output of the hazardous material (e.g., radioactive gasses or otherwise) were to escape from the canister 126 and enter the fractured formation of the storage layer 118, such fractures may allow that material to spread relatively rapidly over a distance comparable in size to that of the fractures. In some aspects, the drillhole 104 may have been drilled for a production of hydrocarbons, but production of such hydrocarbons had failed, e.g., because the storage layer 118 comprised a rock formation (e.g., shale or otherwise) that was too ductile and difficult to fracture for production, but was advantageously ductile for the long-term storage of hazardous material.

As shown, FIG. 1 illustrates the hazardous waste repository 100 in a long term storage (and, in some aspects, monitoring). One or more hazardous material canisters 126 are positioned in the substantially horizontal portion 110 of the drillhole 104. A seal 134 is placed in the drillhole 104 between the location of the canisters 126 in the substantially horizontal portion 110 and an opening of the substantially vertical portion 106 at the terranean surface 102 (e.g., a well head). In this example, the seal 134 is placed at an uphole end of the substantially vertical portion 108. Alternatively, the seal 134 may be positioned at another location within the substantially vertical portion 106, in the radiussed portion 108, or even within the substantially horizontal portion 110 uphole of the canisters 126. In some aspects, the seal 134 may be placed at least deeper than any source of mobile water, such as the mobile water layer 114, within the drillhole 104. In some aspects, the seal 134 may be formed substantially along an entire length of the substantially vertical portion 106.

As illustrated, the seal 134 fluidly isolates the volume of the substantially horizontal portion 110 that stores the canisters 126 from the opening of the substantially vertical portion 106 at the terranean surface 102. Thus, any hazardous material (e.g., radioactive material) that does escape the canisters 126 may be sealed (e.g., such that liquid, gas, or solid hazardous material) does not escape the drillhole 104. The seal 134, in some aspects, may be a cement plug or other plug, that is positioned or formed in the drillhole 104. As another example, the seal 134 may be formed from one or more inflatable or otherwise expandable packers positioned in the drillhole 104.

Prior to a retrieval operation, the seal 134 may be removed. For example, in the case of a cement or other permanently set seal 134, the seal 134 may be drilled through or otherwise milled away. In the case of semi-permanent or removable seals, such as packers, the seal 134 may be removed from the drillhole 104 through a conventional process as is known.

Referring generally to FIG. 1, the example hazardous waste repository 100 may provide for multiple layers of containment to ensure that a hazardous material (e.g., biological, chemical, nuclear) is sealingly stored in an appropriate subterranean layer. In some example implementations, there may be at least twelve layers of containment. In alternative implementations, a fewer or a greater number of containment layers may be employed. First, using spent nuclear fuel as an example hazardous material, the fuel pellets are taken from the reactor and not modified. They may be made from sintered uranium dioxide (UO₂), a ceramic, and may remain solid and emit very little gas other than short-lived tritium. Unless the pellets are exposed to extremely corrosive conditions or other effects that damage the multiple layers of containment, most of the radioisotopes (including the tritium) will be contained in the pellets. Second, the fuel pellets are surrounded by the zircaloy tubes of the fuel rods, just as in the reactor. As described, the tubes can be mounted in the original fuel assemblies, or removed from those assemblies for tighter packing. Third, the tubes are placed in the sealed housings of the hazardous material canister. The housing may be a unified structure or multi-panel structure, with the multiple panels (e.g., sides, top, bottom) mechanically fastened (e.g., screws, rivets, welds, and otherwise). Fourth, a material (e.g., solid or fluid) may fill the hazardous material canister to provide a further buffer between the material and the exterior of the canister. Fifth, the hazardous material canister(s) are positioned (as described above), in a drillhole that is lined with a steel or other sealing casing that extends, in some examples, throughout the entire drillhole (e.g., a substantially vertical portion, a radiussed portion, and a substantially horizontal portion). The casing is cemented in place, providing a relatively smooth surface (e.g., as compared to the drillhole wall) for the hazardous material canister to be moved through, thereby reducing the possibility of a leak or break during deposit or retrieval. Sixth, the cement that holds or helps hold the casing in place, may also provide a sealing layer to contain the hazardous material should it escape the canister. Seventh, the hazardous material canister is stored in a portion of the drillhole (e.g., the substantially horizontal portion) that is positioned within a thick (e.g., 100-200 feet) seam of a rock formation that comprises a storage layer. The storage layer may be chosen due at least in part to the geologic properties of the rock formation (e.g., no mobile water, low permeability, thick, appropriate ductility or non-brittleness).

For example, in the case of shale as the rock formation of the storage layer, this type of rock may offers a level of containment since it is known that shale has been a seal for hydrocarbon gas for millions of years. The shale may contain brine, but that brine is demonstrably immobile, and not in communication with surface fresh water. Eighth, in some aspects, the rock formation of the storage layer may have other unique geological properties that offer another level of containment. For example, shale rock often contains reactive components, such as iron sulfide, that reduce the likelihood that hazardous materials (e.g., spent nuclear fuel and its radioactive output) can migrate through the storage layer without reacting in ways that reduce the diffusion rate of such output even further. Further, the storage layer may include components, such as clay and organic matter, that typically have extremely low diffusivity. For example, shale may be stratified and composed of thinly alternating layers of clays and other minerals. Such a stratification of a rock formation in the storage layer, such as shale, may offer this additional layer of containment. Ninth, the storage layer may be located deeper than, and under, an impermeable layer, which separates the storage layer (e.g., vertically) from a mobile water layer. Tenth, the storage layer may be selected based on a depth (e.g., 3000 to 12,000 ft.) of such a layer within the subterranean layers. Such depths are typically far below any layers that contain mobile water, and thus, the sheer depth of the storage layer provides an additional layer of containment. Eleventh, example implementations of the hazardous waste repository of the present disclosure facilitate monitoring of the stored hazardous material. For example, if monitored data indicates a leak or otherwise of the hazardous material (e.g., change in temperature, radioactivity, or otherwise), or even tampering or intrusion of the canister, the hazardous material canister may be retrieved for repair or inspection. Twelfth, the one or more hazardous material canisters may be retrievable for periodic inspection, conditioning, or repair, as necessary (e.g., with or without monitoring). Thus, any problem with the canisters may be addressed without allowing hazardous material to leak or escape from the canisters unabated.

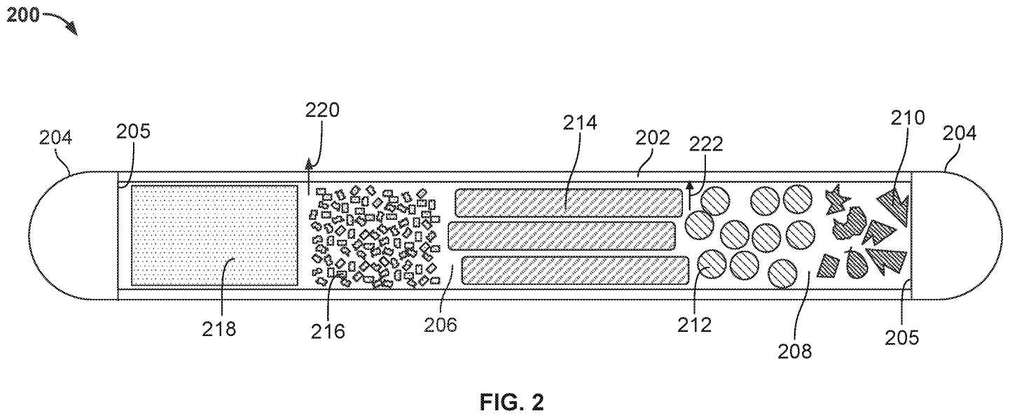

FIG. 2 is a schematic illustration of an example implementation of a radioactive waste canister system 200 (which can be implemented as the hazardous waste canister 126 in FIG. 1) according to the present disclosure. In some aspects, storage and disposal of nuclear waste (such as in the repository 100), such as the form of spent nuclear fuel, sometimes assumes that such forms remain constant from use to disposal. For example, deep, directional drillhole solutions for the disposal of spent nuclear fuel (as show in FIG. 1 as hazardous waste repository 100) can assume that the spent nuclear fuel remains in the fuel assemblies that currently holds it, that the fuel assemblies are loaded into cylindrical canisters, which are then sealed, Then, these canisters are lowered into cased drillholes for disposal deep underground (1 to 1.5 km).

The present disclosure describes example implementations of radioactive waste canister systems and methods that enclose and store all or most kinds of nuclear waste, such as the nuclear waste forms (1)-(7) described herein, as well as other nuclear (or generally, hazardous) waste forms. The example implementations of a radioactive waste canister system according to the present disclosure can be suitable for disposal in deep, human-unoccupiable drillholes (or even shallow, human-occupiable mined repositories). In some aspects, the use of such example implementations of a radioactive waste canister system according to the present disclosure can be preferable for disposal in deep, human-unoccupiable drillholes due to, for example, the inability to regularly and conveniently examiner (visually or otherwise) the structural integrity (or other characteristic) of such canister systems.

Example implementations of a radioactive waste canister system according to the present disclosure can take advantage of the fact that many of the listed nuclear waste forms either consist of relatively small, physical components (e.g., pellets, capsules) or can be processed into such relatively small, physical components (e.g., by removing fuel pellets from fuel assemblies, or—for the case of vitrified fuel—by cracking, crushing, cutting, or melting).

As shown in FIG. 2, the radioactive waste canister system 200 includes, e.g., a substantially cylindrical, housing 202 that defines an interior volume 206 into which one or more nuclear waste forms can be enclosed along with other components as described in more detail herein. Each end of the housing 202 can be enclosed by or include an end cap 204 (that can be mechanically attached to the housing 202 or otherwise). Thus, in some aspects, the housing 202 is a tubular open at both ends 205 (i.e., open ends) with end caps 204 removably attachable to such ends; alternatively, one of the end caps 204 may be integrally formed (during construction or after, such as by welding) with the housing 202 to form a container with a single opening into the interior volume 206.

In example implementations, the housing 202 and end caps 204 (or just housing 202) can be made of a corrosion-resistant metal, such as carbon-steel or stainless steel or nickel alloy, and cylindrical in shape. In some aspects, therefore, the housing 202 can be made from a material that prevents or reduces an escape of radioactive fluid 222 there through, but does allow transmission of gamma radiation 220 from the enclosed nuclear waste form(s) through the housing 202 and to the environment.

As shown in this example implementation, the ends 205 of the open housing 202, once sealed shut, can be rounded to avoid protrusions that can cause the canister system 200 to get stuck in a drillhole. For example, the end caps 204 can be rounded to provide the rounded ends of the canister system 200. In some aspects, the end caps 204 on the canister system 200 consist of a heavy material (such as lead or tungsten) that creates a shield to prevent or reduce gamma radiation 220 generated from the enclosed nuclear waste form(s) to escape to the environment (as well as radioactive fluid 222).

As shown in FIG. 2, in the example implementation, one or more nuclear waste forms is enclosed within the interior volume 206 and is mixed with a granular material 208. In some aspects, the one or more nuclear waste forms can be mixed with the granular material 208 prior to placing the mixture into the interior volume 206. In some aspects, the one or more nuclear waste forms (labeled 210-218) can be placed in the interior volume 206 simultaneously with the granular material 208 to form a random mixture in the canister system 200. As the granular material 208 is used to fill the canister system 200, the housing 202 can be vibrated or otherwise shaken or jarred to cause the material 208 to flow and fill in gaps between the one or more nuclear waste forms 210-218.

In some aspects, a lubricant can also be added to the mixture of granular material 208 and nuclear waste form(s) 210-218 to improve the filling process. The lubricant can be a solid (such as graphite), a liquid (such as water or alcohol or mineral oil), or a gas (such as helium or argon or air). When the canister system 200 is fully loaded with nuclear waste and granular material 208, there may be few large gaps in the mixture, that is, gaps of 1 cm size or larger. The absence of such gaps can be verified by X-ray or acoustic means, and if desired, steps (such as local vibrations) can be used to cause the granular material 208 to fill the gaps. In some aspects, gaps of such dimensions can be tolerated.

In some aspects, the granular material 208 comprises quartz grains, or grains that are predominantly quartz, such as Sahara Desert sand or ordinary beach sand. The purpose of the granular material 208 can be multifold. For example, the granular material 208 can provide mechanical support and help increase a resistance to crushing for the housing 202. As another example, the granular material 208 can provide thermal conductivity that enhances a flow of heat from the one or more nuclear waste forms 210-218 to the housing 202 (exterior) surface, from which it conducts and convects into a surrounding liquid and/or rock in which the deep, directional drillhole is formed.

As another example, the granular material 208 can occupy space that might otherwise may be filled (in the case of a leak) by water (such as brine in the subterranean formation), as water is a moderator that can enhance reactivity (e.g., nuclear chain reactions involving uranium and plutonium). Further, regarding potential reactivity, in some aspects, two or more nuclear waste 210-218 forms that can be enclosed within the canister system 200 can be selected to ensure that the combination of such nuclear waste forms do not form a critical mass.

In example implementations, the granular material 208 can comprise smooth rounded particles, since such particles flow more readily to fill gaps. Ragged sand particles tend to jam against each other. Desert sand, particularly from the Sahara Desert, has been rounded over thousands of years of dune formation, during which time grains ground against other grains to smooth the surface of the sand.

In some aspects, the granular material 208 can comprise hollow glass spheres, such as microspheres made by MoSci (GL0237B). Such spheres can have an average density of 150 kg per cubic meter and have 150 psi crush strength to support the nuclear waste forms 210-218 in the volume 206. The glass spheres can be small enough to be able to fit within spaces in the volume between, e.g., components of a spent nuclear fuel (e.g., PWR). In some aspects, space within the inner volume 206 can be filled (along with the granular material 208) by a pressurized gas, such as hydrogen or helium.

In some aspects, the granular material 208 can comprise be natural sand, or it can consist of artificially-manufactured shapes of sand. Sand and glass both have densities of about 1600 kg per cubic meter. For a large canister system 200, the internal volume 206 might be 4 cubic meters. If half of the volume 206 were filled with sand, then the weight of the sand would be 3200 kg or about 3.2 tons. In some instances it may be considered beneficial to use a material that has a lower weight than natural sand as the granular material 208. This can be achieved, for example, by making the granular material 208 out of aerogel spheres (e.g., graphene aerogel). Aerogel has a density typically 100 kg per cubic meter, and in a random array of spheres, settled by vibration to fill loose voids, the density would be about 65 kg per cubic meter. Such aerosol spheres (such as “marble sized” spheres that are typically larger than natural sand) would add only about 130 kg=0.13 tons of weight to a 50% filled canister system 200.

In the case of at least one of the nuclear waste forms 210-218 being spent nuclear fuel, such waste generates typically 100 to 200 watts in one PWR fuel assembly. Aerogel, by itself, has poor thermal conductivity, so use of aerogel as all or part of the granular material 208 can lead to a thermal isolation of the spent nuclear fuel waste form, and the heat generation can then lead to a large temperature rise of the spent nuclear fuel during storage and disposal. If it is deemed preferable to keep the temperature rise of the waste low; then the spaces between the aerogel spheres (as the granular material 208) can be filled with a gas that has high heat conductivity, such as hydrogen or helium. Helium, for instance, is non-flammable, and introduction of helium into the canister system 200 allows an external helium-leak detector to be used to help verify, e.g., the quality of welds that seal the end caps 204 to the housing 202. The helium can be pressurized to enhance its performance for leak detection, and to provide additional support of the housing 202 against collapse from a large external pressure that it may experience when emplaced in a drillhole from, e.g., brine that can fill the internal volume of the drillhole (cased or otherwise).

Example implementations of the canister system 200 as described here can contain a mixture of waste shapes and forms. For example, it can be used for randomly-shaped fragments of recovered core-melt from a nuclear accident (such as the ones at Fukushima, Chernobyl, and Three-Mile Island). A canister system 200 can be used for a mixture of nuclear waste forms, including waste from different sources (e.g., a TRIGA research reactor, medical waste, and a commercial nuclear reactor) in the same housing 202. Such a combined system can be particularly useful in parts of the world that have only small, but varied, amounts of nuclear waste. Of course, in some aspects, a canister system 200 as described herein can enclose simply a single nuclear waste form.

FIG. 2 illustrates the example implementation in which more than one, and actually several, nuclear waste forms are stored within a single canister system 200. For example, calcine waste 218 is contained in a bag that is then placed in the canister; such a bag is optional, but for a granular waste it has advantages. The bag can be made of metal or some other material and can, for example, ease handling of this form of nuclear waste. In some aspects, the bag is flexible so it can conform its shape under pressure from the granular material 208.

In FIG. 2, the spent nuclear fuel waste form 216 has been removed from its fuel assembly and from the cladding (and reduced to spent nuclear fuel pellets 216). In this example, no attempt has been made to organize the pellets into a minimum volume configuration, although that also can be done during a pre-processing of this waste form (since they are cylindrical in shape, they can be stacked, for example).

In FIG. 2, the largest nuclear waste forms placed in the canister are the cesium-137 and strontium-90 capsules 214, which are assumed to have the dimensions given previously (as these are the dimensions of the capsules stored at the Hanford facility in the state of Washington). These capsules are 3.5 inch in diameter. For these capsules, the inner diameter of the housing 202 may be larger than 3.5 inches (e.g., 3.6 inches to 4 inches or larger). Such housings 202 can fit conveniently into standard directional drillholes formed with conventional drilling techniques.

For a shorter storage region (such as a mined repository), a larger diameter housing 202 can be used. For example, the canister system 200 shown in FIG. 2 illustrates that several cesium or strontium capsules 214 (e.g., 3 or 7 or another number) can be stored side-by-side. For such large capsules 214, placement can be done carefully. For example, seven capsules 214 can be wrapped together (one in center, six surrounding), the space between the wrapped capsules 214 filled with the granular material 208, a thin wrap put around the combination to hold the material 208, and then the combination lowered into the canister interior volume 206. Similarly, pebble bed reactor pebbles can be close-stacked, or they can simply be lowered into the canister interior volume 206 to slip into place. The option chosen depends on, e.g., whether maximum filling of the canister system 200 is considered desirable or cost effective.

FIG. 2 also shows that the canister system 200 encloses shards 210 of nuclear waste, either from pieces of vitrified waste or from pieces of fuel melt from a nuclear reactor accident. With such waste forms, careful placement may not be necessary and instead, the shards 210 can be “dropped” into the canister volume 206 one piece after another and mixed with the granular material 208.

In the example canister system 200 of FIG. 2, once the waste 210-218 and granular material 208 are in place, but before the canister volume 206 is sealed (e.g., with an end cap 204), there is the option of vibrating or otherwise shaking or jarring the housing 202. In an example implementation, one end 205 of the canister housing 202 is sealed before the shaking is done, and the canister housing 202 is placed on end (with the open end 205 vertically upward). Such shaking can induce the grains of the granular material 208 to move and to fill in any large remaining voids within the interior volume 206. More granular material 208 can be added from the open end 205 to further fill the interior volume 206 of the canister housing 202. X-ray and/or acoustic methods can be used to identify gaps to be filled and to direct the vibration or jarring in the most effective way. Before the top of the canister housing 202 is sealed (e.g., with an end cap 204), the interior volume 206 of the canister housing 202 can be evacuated to remove air or other gas. The volume 206 canister system 200 can remain as a vacuum, or it can then be filled with a gas (such as argon or helium) or with a liquid which remains in place after sealing.

As described, some nuclear waste forms 210-218 can be dropped, i.e., randomly inserted into the interior volume. Such random insertion, or dropping, that is used to fill the canister housing 202 may not result in a maximum amount of nuclear waste per volume of the canister system 200. However, conventional methods that dispose of complete fuel assemblies are also not volume efficient. By allowing for random insertion of one or more of the nuclear waste forms 210-218 into the canister housing 202, more time efficient and less complex processes can be used in the handling of the nuclear waste, and that can add significantly to the safety of personnel and to the reduction of cost.

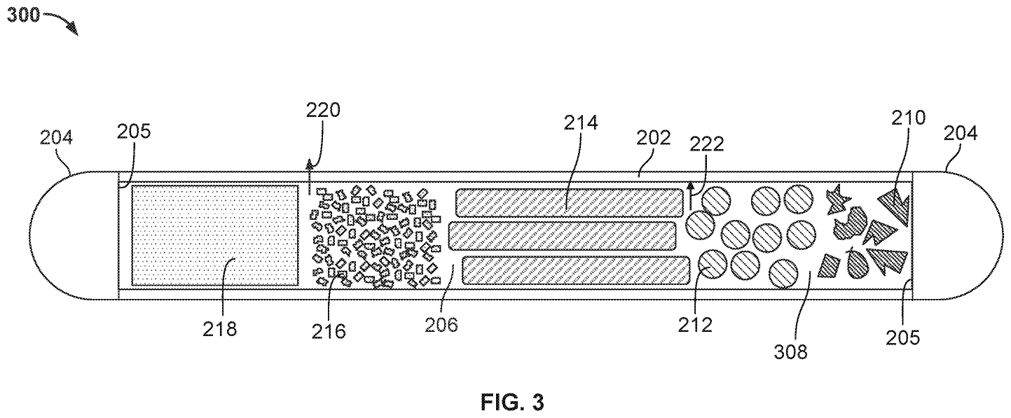

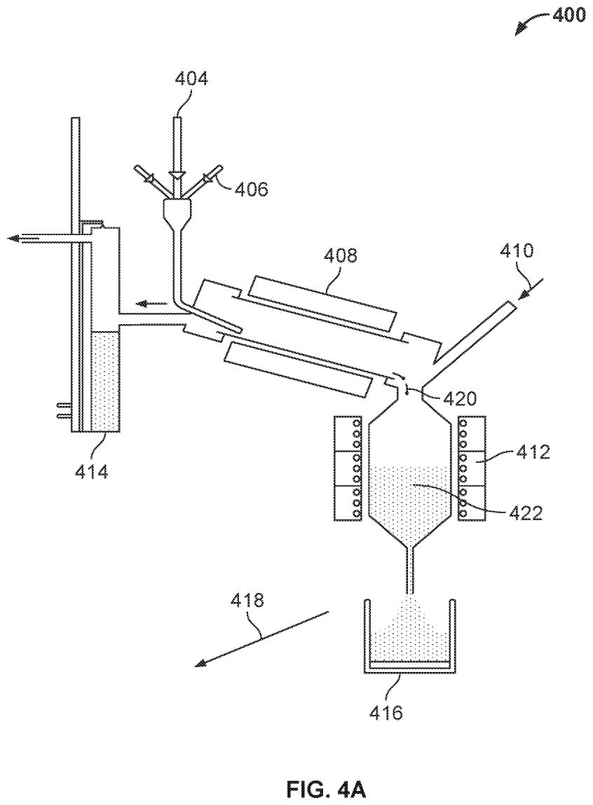

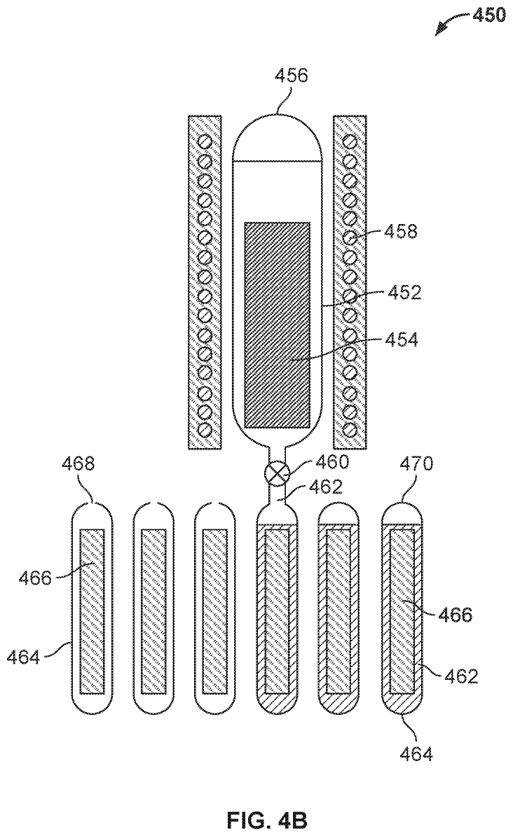

FIG. 3 shows another example implementation of a hazardous waste canister 300 (which can be implemented as the hazardous waste canister 126 in FIG. 1) that stores one or more (and in some aspects, two or more) forms of nuclear waste along with glass 308 or vitrified waste 308 occupying the empty space between such pieces of waste (which are described, along with certain components of the canister 300, with reference to FIG. 2). The glass 308 can be added to the interior volume 206 of the canister 300 after the form(s) of waste 210-218 are already in place (as is done with fuel assemblies in FIG. 4B), or it can be added to the canister 300 as the canister 300 is being filled with the two or more forms of nuclear waste 210-218, or it can be done in stages, with some waste 210-218 added, then glass 308, then waste, then glass, and continuing on with such stages until the canister 300 is filled to the desired fill.

As shown, the radioactive waste canister system 300 includes a substantially cylindrical housing 202 that defines an interior volume 206 into which one or more nuclear waste forms 210-218 can be enclosed along with a molten glass material 308 (that hardens) as described in more detail herein. Each open end 205 of the substantially cylindrical housing 202 can be enclosed by or include an end cap 204 (that can be mechanically attached to the housing 202 or otherwise). Thus, in some aspects, the housing 202 of canister system 300 is a tubular open at both ends 205 with end caps 204 removably attachable to such ends; alternatively, one of the end caps 204 may be integrally formed (during construction or after, such as by welding) with the housing 202 to form a container system 300 with a single opening into the interior volume.

In example implementations, the housing 202 and end caps 204 (or just housing 202) can be made of a corrosion-resistant metal, such as carbon-steel or stainless steel or nickel alloy, and cylindrical in shape. In some aspects, therefore, the housing 202 can be made from a material that prevents or reduces an escape of radioactive fluid 222 there through, but reduces transmission of gamma radiation 220 from the enclosed nuclear waste form(s) 210-218 through the housing 202 and to the environment. Such materials can be lead, tungsten, and depleted uranium.

As shown in this example implementation of the canister system 300, the ends 205 of the open housing 202, once sealed shut, can be rounded to avoid protrusions that can cause the canister system 300 to get stuck in a drillhole. For example, the end caps 204 can be rounded to provide the rounded ends of the canister system 300. In some aspects, the end caps 204 on the housing 202 consist of a material that absorbs gamma rays (such as lead or tungsten) that creates a shield to prevent or reduce gamma radiation generated from the enclosed nuclear waste form(s) 210-218 to escape to the environment (as well as radioactive fluids).

In some aspects, the glass 308 can be mixed with sand or other material such as glass spheres or vitrified nuclear waste (also labeled 308) (such as a mixture of glass and calcined waste). In some aspects, the canister system 300 that contains the waste can be pre-heated so that the glass 308 entering the canister system 300 will not cool upon contact with the waste, but will continue to be in a liquid phase. The cooling and solidification of the glass 308 would take place at a later time subsequent to filling.

Some nuclear waste, particularly the kind known as calcinated waste, is mixed with molten glass and then the combination is solidified to form vitrified waste 308. Such a process is called vitrification, and the mixture is called vitrified waste. Vitrification occurred due to the belief that the glass would be stable for tens, to hundreds, to thousands of years; thus, the glass 308 can isolate the waste from the environment until most of the radioactivity had decayed.

The present disclosure describes systems and methods for vitrifying forms of radioactive or nuclear waste other than calcine nuclear waste. For example, spent nuclear fuel assemblies containing spent nuclear fuel (SNF) contain significant “empty space,” that is, space normally filled with water (when the assembly is still in the nuclear reactor or in a cooling pool) or air (if the assembly has been removed and drained, and is ready for transport). For a SNF assembly, the empty space is typically about two-thirds of the volume of a SNF assembly. If the SNF assembly is placed (as a whole, without deconstruction or disassembly) in a hazardous waste canister, such empty space can be an even larger fraction. In some aspects, such a hazardous waste canister that encloses a SNF assembly (all, as a whole, or parts as disassembled) can have an empty portion filled with molten glass (that then cools and hardens).

An example system 400 for vitrifying liquid waste is shown in FIG. 4A (see Étienne Vernaz and Jérôme Bruezière/Procedia Materials Science 7 (2014) 3-9)). FIG. 4A shows stages for taking liquid waste 404 (and possible additives 406), turning it into calcinated waste 420 (in calciner 408), and then mixing it with melted glass 422 (from glass frit 410) at a temperature, e.g., of 1180° C. (in glass melter 412) to make the mixture known as vitrified waste 418. The liquid mixture of calcinated waste and glass (e.g., borosilicate glass) flows into a container 416. When full, the container 416 is removed and the mixture inside cools and solidifies. The vitrified waste 418 can be removed from the container 416 or left in it for storage or disposal. In this example, the system 400 also includes a dust scrubber 414.

An example system 450 and process emplacing vitrified waste in hazardous waste canister systems (such as systems 300) is shown in FIG. 4B. FIG. 4B shows system 405 that includes an oven 458 that contains glass 454. In some aspects, this can be a cylinder of glass 454; it can also be a container 452 containing pieces of solid glass 454, such as glass frit. The oven 458 shown is an induction oven, but other kinds of ovens can be used. The purpose of the oven 458 is to heat the glass 454 to melt it, or to keep it hot and melted (if it is inserted into the oven 458 already in liquid form). Below the oven 458 is shown a series of hazardous waste canister systems 464 (which can be the same or substantially similar, for instance, to hazardous waste canister system 300), each partially filled with at least one SNF assembly 466.

In turn, each canister 464 is placed under the oven 458, and molten glass 462 flows into the canister 464 (through an open end 468 of the canister 464), surrounding and filling the space within and between the canister 464 and the SNF assembly 466. In an example configuration, the glass 462 also flows into the SNF assembly 466 and fills the empty space that exists within the assembly 466. In some aspects, the SNF assembly 466 can be evacuated (pumped) prior to the filling. In other aspects, the empty space within the canister 464 (not taken up by the assembly 466) can be filled with air, or another gas, such as nitrogen, argon, or helium. If there is gas fill, then the configuration can be designed to allow that gas to escape. In some aspects, the glass 454 used in the oven 458 can be a cylinder of vitrified waste, such as glass that is already mixed with calcined nuclear waste (as described with reference to FIG. 4A). Using calcined waste to fill the empty space within the canister 464 would increase the amount of waste stored in one canister 464.

In some aspects, the canister 464 that holds the SNF assembly 466 can be different from the canister system that is used in disposal (such as canister system 300), such as in a hazardous waste repository formed in a human-unoccupiable directional drillhole (e.g., wellbore or borehole). The canister 464 can be removed prior to disposal, or it can be left in place surrounding the vitrified waste, and provide a container that is then placed inside the disposal canister system (e.g., canister system 300). The vitrification of the SNF assembly would improve the robust strength of the assembly, making it less susceptible to damage if dropped (e.g., within the directional drillhole) or otherwise roughly handled.

In FIG. 4B, the glass 454 is initially put into the container 452 within the oven 458 by opening the lid 456. It can also be introduced continuously, either as a liquid (if hot) or as glass beads or frits or fragments (if solidified). The container 452 can be glass, metal, ceramic, other material, or a combination (for example, a glass container with a metal lid). The induction oven 458 can be used to heat the structure that holds the vitrified waste cylinder (e.g., 454), in which case the heat can be transferred to the cylinder by conduction, convection, and radiation, or it can be used to heat the glass directly; if used to heat the vitrified waste (e.g., 454) directly, then a conductive material might be mixed in with the glass, such as small fragments of metal, to absorb the energy contained in the changing magnetic field of the induction oven. The valve 460 shown in FIG. 4B can stop the downward flow of molten glass 462 when a new canister 464 is being put in place under the oven 458.

In other aspects consistent with FIG. 4B, instead of putting a vitrified waste cylinder 454 into the oven 458 one at a time, they can be fed in continuously. Instead of closing a valve 460 above the canister 464 each time a new canister 464 is put in place (e.g., under the outlet of the over 458), there can be a valve that switches the melted glass flow from one canister 464, once it is filled, immediately to another canister 464 In another aspect, the glass 454 can be mixed with sand or other material such as glass spheres.

In another aspect, the canisters 464 containing the one or more SNF assemblies 466 can be pre-heated so that the glass 462 entering the canisters 464 will not cool upon contact with the fuel assembly 466, but will continue to be in a liquid phase. The cooling and solidification of the glass 462 can take place at a later time subsequent to fill by the molten glass 462.

In another example implementation, a hazardous waste canister configured to enclose and store two or more forms of nuclear waste (such as canister systems 200 and/or 300) can also include molten glass or vitrified waste that fills up an empty volume within the canister and between the two or more forms of nuclear waste. For example, the two or more forms of waste can include small containers (such as the containers currently used to hold Cs-137 and Sr-90 waste currently in temporary storage at the Hanford Laboratory in Washington State); shards of “corium” (the material that results from a nuclear meltdown, such as happened at the Fukushima nuclear power plant); granules called calcined waste, and/or other forms of waste such as SNF pellets or high level waste.

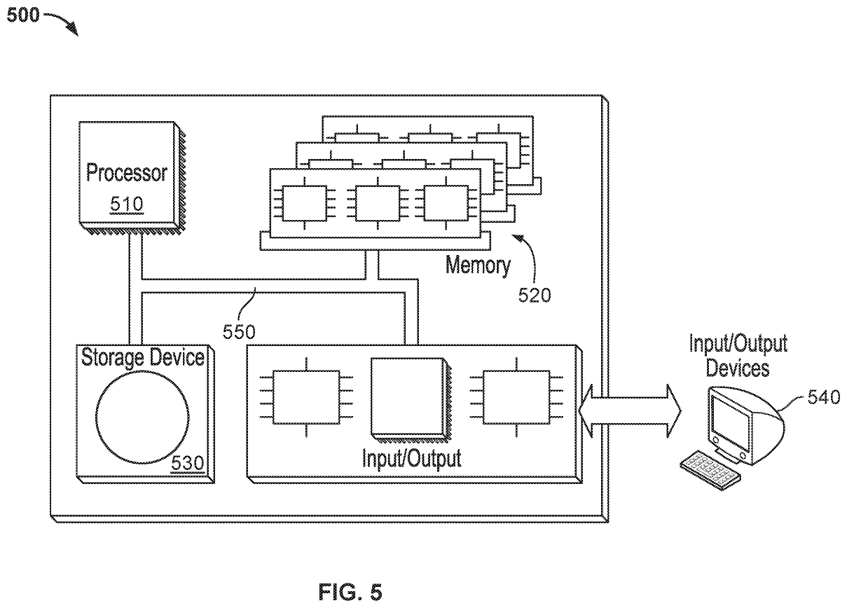

FIG. 5 is a schematic illustration of an example controller 500 (or control system) that is operable, e.g., to control operations of the systems 400 or 450. The controller 500 is intended to include various forms of digital computers, such as printed circuit boards (PCB), processors, digital circuitry, or otherwise that is part of a vehicle. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output device 540. Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the controller 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, a tape device, flash memory, a solid state device (SSD), or a combination thereof.

The input/output device 540 provides input/output operations for the controller 500. In one implementation, the input/output device 540 includes a key board and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The present disclosure describes a number of example implementations. For example, in a first example implementation, a hazardous waste canister includes a housing that includes at least one open end and defines an interior volume; and an end cap sized and configured to attach to the at least one open end of the housing to enclose the interior volume. The housing is configured to enclose at least one hazardous waste form within the interior volume substantially encased within a hardenable, molten glass material.

In an aspect combinable with the first example implementation, the at least one hazardous waste form includes at least one chemical waste form or at least one biological waste form, or both.

In another aspect combinable with any of the previous aspects of the first example implementation, the at least one hazardous waste form includes at least one nuclear waste form.

In another aspect combinable with any of the previous aspects of the first example implementation, the housing is configured to prevent passage of a radioactive fluid there through.

In another aspect combinable with any of the previous aspects of the first example implementation, the housing is further configured to allow passage of a plurality of gamma rays generated by the at least one nuclear waste form there through.

In another aspect combinable with any of the previous aspects of the first example implementation, the end cap is configured to prevent passage of a radioactive fluid there through.

In another aspect combinable with any of the previous aspects of the first example implementation, the end cap is further configured to prevent passage of a plurality of gamma rays generated by the plurality of nuclear waste forms there through.

In another aspect combinable with any of the previous aspects of the first example implementation, the housing is made of at least one of a carbon-steel, a stainless steel, or a nickel alloy.

In another aspect combinable with any of the previous aspects of the first example implementation, the end cap is made of at least one of lead or tungsten or uranium.

In another aspect combinable with any of the previous aspects of the first example implementation, the at least one open end includes a first open end at a first end of the housing and a second open end at a second end of the housing opposite the first end.

Another aspect combinable with any of the previous aspects of the first example implementation further includes another end cap sized and configured to attach to at least one of the first or second open ends to at least partially enclose the interior volume.

In another aspect combinable with any of the previous aspects of the first example implementation, the molten glass material includes molten glass and calcined nuclear waste.

In another aspect combinable with any of the previous aspects of the first example implementation, the molten glass includes a liquefied cylinder of glass.

In another aspect combinable with any of the previous aspects of the first example implementation, the molten glass is formed of a granular solid.

In another aspect combinable with any of the previous aspects of the first example implementation, the granular solid includes sand.

In another aspect combinable with any of the previous aspects of the first example implementation, at least a portion of the canister is configured for pre-heating prior to insertion of the hardenable, molten glass material.

In another aspect combinable with any of the previous aspects of the first example implementation, the at least one nuclear waste form includes of plurality of nuclear waste forms, with at least one of the plurality of nuclear waste forms being different than at least another of the plurality of nuclear waste forms.

In a second example implementation, a method includes identifying a hazardous waste canister that includes a housing that includes at least one open end and defines an interior volume; moving at least one hazardous waste form through the at least one open end and into the interior volume; and filling at least a portion of the interior volume with a hardenable, molten glass material.

In an aspect combinable with the second example implementation, the at least one hazardous waste form includes at least one chemical waste form or at least one biological waste form, or both.

In another aspect combinable with any of the previous aspects of the second example implementation, the at least one hazardous waste form includes at least one nuclear waste form.

In another aspect combinable with any of the previous aspects of the second example implementation, the filling occurs subsequent to the moving.

In another aspect combinable with any of the previous aspects of the second example implementation, the at least one hazardous waste form fills a first percentage of the interior volume, and the hardenable, molten glass fills a second percentage of the interior volume, and a sum of the first and second percentages is about 100% of the interior volume.

Another aspect combinable with any of the previous aspects of the second example implementation further includes sealing the at least one open end with an end cap sized and configured to attach to the at least one open end of the housing.

In another aspect combinable with any of the previous aspects of the second example implementation, the housing is configured to prevent passage of a radioactive fluid there through, and the housing is further configured to allow passage of a plurality of gamma rays generated by the plurality of nuclear waste forms there through.

In another aspect combinable with any of the previous aspects of the second example implementation, the end cap is configured to prevent passage of a radioactive fluid there through, and the end cap is further configured to prevent passage of a plurality of gamma rays generated by the plurality of nuclear waste forms there through.

In another aspect combinable with any of the previous aspects of the second example implementation, the housing is made of at least one of a carbon-steel, a stainless steel, or a nickel alloy.

In another aspect combinable with any of the previous aspects of the second example implementation, the end cap is made of at least one of lead or tungsten or uranium.

In another aspect combinable with any of the previous aspects of the second example implementation, the at least one open end includes a first open end at a first end of the housing and a second open end at a second end of the housing opposite the first end, the canister further including another end cap sized and configured to attach to at least one of the first or second open ends to at least partially enclose the interior volume.

In another aspect combinable with any of the previous aspects of the second example implementation, the molten glass material includes molten glass and calcined nuclear waste.

In another aspect combinable with any of the previous aspects of the second example implementation, the molten glass includes a liquefied cylinder of glass.

In another aspect combinable with any of the previous aspects of the second example implementation, the molten glass is formed of a granular solid.

In another aspect combinable with any of the previous aspects of the second example implementation, the granular solid includes sand.

Another aspect combinable with any of the previous aspects of the second example implementation further includes pre-heating the canister prior to filling.

In another aspect combinable with any of the previous aspects of the second example implementation, filling includes pouring the hardenable, molten glass material from a heater into the at least one open end.

In another aspect combinable with any of the previous aspects of the second example implementation, the heater includes an induction oven.

In another aspect combinable with any of the previous aspects of the second example implementation, the at least one nuclear waste form includes of plurality of nuclear waste forms, with at least one of the plurality of nuclear waste forms being different than at least another of the plurality of nuclear waste forms

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A hazardous waste canister, comprising:
a housing that comprises at least one open end and defines an interior volume; and
an end cap sized and configured to attach to the at least one open end of the housing to enclose the interior volume, wherein
the housing is configured to enclose a plurality of nuclear waste forms within the interior volume, with at least one of the plurality of nuclear waste forms different than at least another of the plurality of nuclear waste forms.

2. The hazardous waste canister of claim 1, wherein the housing is configured to prevent passage of a radioactive fluid there through, and the housing is further configured to allow passage of a plurality of gamma rays generated by the plurality of nuclear waste forms there through.

3. The hazardous waste canister of claim 1, wherein the end cap is configured to prevent passage of a radioactive fluid there through, and the end cap is further configured to prevent passage of a plurality of gamma rays generated by the plurality of nuclear waste forms there through.

4. The hazardous waste canister of claim 1, wherein the housing is made of at least one of a carbon-steel, a stainless steel, or a nickel alloy.

5. The hazardous waste canister of claim 1, wherein the end cap is made of at least one of lead or tungsten.

6. The hazardous waste canister of claim 1, wherein the at least one open end comprises a first open end at a first end of the housing and a second open end at a second end of the housing opposite the first end, the canister further comprising another end cap sized and configured to attach to at least one of the first or second open ends to at least partially enclose the interior volume.

7. The hazardous waste canister of claim 1, wherein the plurality of nuclear waste forms include at least two of:
Cesium-137 or Strontium-90 capsules;
spent nuclear fuel pellets;
vitrified nuclear waste that comprises glass-encased nuclear fuel;
one or more fragments of a melted nuclear core;
calcine waste that comprises a granular solid;
pebble bed nuclear reactor pellets; or
a portion of transuranic waste.

8. The hazardous waste canister of claim 1, wherein the housing is configured to enclose a granular material to fill one or more voids in the interior volume between the plurality of nuclear waste forms.

9. The hazardous waste canister of claim 8, wherein the granular material comprises sand.

10. The hazardous waste canister of claim 9, wherein the sand comprises quartz.

11. The hazardous waste canister of claim 8, wherein the granular material comprises aerogel material.

12. The hazardous waste canister of claim 8, wherein the granular material comprises hollow glass spheres.

13. The hazardous waste canister of claim 8, wherein the housing is configured to enclose a mixture that comprises the granular material and the plurality of nuclear waste forms.

14. The hazardous waste canister of claim 13, wherein the housing is configured to enclose a lubricant.

15. The hazardous waste canister of claim 14, wherein the housing is configured to enclose a mixture that comprises the granular material, the plurality of nuclear waste forms, and the lubricant.

16. The hazardous waste canister of claim 1, wherein a difference in the at least one of the plurality of nuclear waste forms and the at least another of the plurality of nuclear waste forms comprises at least one of a size, a shape, or a type of nuclear waste.

17. A method, comprising:
identifying a hazardous waste canister that comprises a housing that comprises at least one open end and defines an interior volume;
moving a plurality of nuclear waste forms through the at least one open end and into the interior volume, at least one of the plurality of nuclear waste forms being different than at least another of the plurality of nuclear waste forms; and
sealing the at least one open end with an end cap sized and configured to attach to the at least one open end of the housing.

18. The method of claim 17, wherein the housing is configured to prevent passage of a radioactive fluid there through, and the housing is further configured to allow passage of a plurality of gamma rays generated by the plurality of nuclear waste forms there through.

19. The method of claim 17, wherein the end cap is configured to prevent passage of a radioactive fluid there through, and the end cap is further configured to prevent passage of a plurality of gamma rays generated by the plurality of nuclear waste forms there through.

20. The method of claim 17, wherein the housing is made of at least one of a carbon-steel, a stainless steel, or a nickel alloy.

21. The method of claim 17, wherein the end cap is made of at least one of lead or tungsten.

22. The method of claim 17, wherein the at least one open end comprises a first open end at a first end of the housing and a second open end at a second end of the housing opposite the first end, the canister further comprising another end cap sized and configured to attach to at least one of the first or second open ends to at least partially enclose the interior volume.

23. The method of claim 17, wherein the plurality of nuclear waste forms include at least two of:
Cesium-137 or Strontium-90 capsules;
spent nuclear fuel pellets;
vitrified nuclear waste that comprises glass-encased nuclear fuel;
one or more fragments of a melted nuclear core;
calcine waste that comprises a granular solid;
pebble bed nuclear reactor pellets; or
a portion of transuranic waste.

24. The method of claim 17, further comprising inserting a granular material into the interior volume to fill one or more voids in the interior volume between the plurality of nuclear waste forms.

25. The method of claim 24, wherein the granular material comprises a sand.

26. The method of claim 25, wherein the sand comprises quartz.

27. The method of claim 24, wherein the granular material comprises aerogel material.

28. The method of claim 24, wherein the granular material comprises hollow glass spheres.

29. The method of claim 24, further comprising inserting a mixture that comprises the granular material and the plurality of nuclear waste forms into the interior volume.

30. The method of claim 24, further comprising inserting a lubricant into the interior volume.

31. The method of claim 30, further comprising inserting a mixture that comprises the granular material, the plurality of nuclear waste forms, and the lubricant into the interior volume.

32. The method of claim 17, wherein a difference in the at least one of the plurality of nuclear waste forms and the at least another of the plurality of nuclear waste forms comprises at least one of a size, a shape, or a type of nuclear waste.

33. The method of claim 30, further comprising repeatedly moving the canister to mix the granular material and the plurality of nuclear waste forms in the interior volume.

34. The method of claim 33, further comprising repeatedly moving the canister to mix the granular material, the plurality of nuclear waste forms, and the lubricant in the interior volume.

35. The method of claim 34, wherein repeatedly moving comprises shaking or vibrating.
